(19) United States
(12) Patent Application Publication
(10) Pub. No.: US 2020/0406398 A1
(43) Pub. Date: Dec. 31, 2020

(54) WELDING METHOD

(71) Applicant: Fujikura Ltd., Tokyo (JP)

(72) Inventors: Toshitaka Namba, Sakura-shi (JP); Kenji Takahashi, Sakura-shi (JP); Daisuke Oku, Sakura-shi (JP); Ryo Yamaguchi, Sakura-shi (JP)

(73) Assignee: Fujikura Ltd., Tokyo (JP)

(21) Appl. No.: 16/910,648

(22) Filed: Jun. 24, 2020

(30) Foreign Application Priority Data
Jun. 26, 2019 (JP) 2019-118347

(51) Int. Cl. B23K 26/24; B23K 26/082; B23K 31/00

(52) U.S. Cl. CPC B23K 26/24; B23K 2101/18; B23K 31/003; B23K 26/082

(57) ABSTRACT

A welding method for welding a first metal member to a second metal member, where the first metal member is plate-shaped, includes: bringing the first metal member into contact with the second metal member; and radiating a laser beam along a spiral scanning pattern straddling an interface line between the first metal member and the second metal member.

### CROSS-REFERENCE TO RELATED APPLICATIONS

This application claims priority from Japanese patent application No. 2019-118347 filed Jun. 26, 2019, the content of which is incorporated herein by reference.

### TECHNICAL FIELD

The present invention relates to a welding method.

### BACKGROUND

Japanese Unexamined Patent Application, First Publication No. 2000-61673 discloses a welding method in which two metal members are brought into contact with each other in a T shape and contact portions are welded to each other by a laser beam. In this type of welding method, it is conventional to radiate the laser beam to a single point in a concentrated manner.

In a case where one of the two metal members has a thin plate shape, if the laser beam is radiated at a single point in a concentrated manner, the thin plate-shaped metal member may be warped due to local heat generation.

### SUMMARY

The present invention has been made in consideration of such circumstances, and one or more embodiments of the present invention provide a welding method capable of suppressing the occurrence of warpage in a thin plate-shaped metal member when the thin plate-shaped metal member is welded to another metal member.

A welding method according to one or more embodiments of the present invention is a welding method for welding a first metal member and a second metal member to each other, the first metal member being thin plate-shaped. The welding method includes bringing the first metal member and the second metal member into contact with each other, and radiating a laser beam along a spiral scanning pattern straddling an interface line between the first metal member and the second metal member.

According to one or more embodiments, since the laser beam is radiated along the spiral scanning pattern straddling the interface line, as compared to a case where the laser beam is concentratedly radiated to a single point, it is possible to suppress a situation in which the first metal member locally generate heat and is warped. In addition, the joined portion between the first metal member and the second metal member can be formed in the region where the scanning pattern is set. Thus, as compared to a case where the laser beam is concentratedly radiated to a single point, the joining area is increased, and the bonding strength can be increased. Moreover, since the spiral scanning pattern straddles the interface line, the scanning pattern crosses the interface line multiple times. For this reason, the radiation position of the laser beam with respect to the interface line is unlikely to change due to an error in the apparatus, and it is also possible to suppress variations in the bonding strength. Moreover, since the scanning pattern has a spiral shape, the first metal member and the second metal member that are melted with the scanning of the laser beam are agitated. Accordingly, an interface between the first metal member and the second metal member is less likely to be formed inside the joined portion, and the bonding strength can be further improved.

Here, the first metal member may have a first contact surface that contacts the second metal member, the second metal member may have a second contact surface that contacts the first contact surface, and a side surface that extends in a direction intersecting the second contact surface, and the scanning pattern may be set on the side surface and the first contact surface.

In addition, a contact region between the first metal member and the second metal member may be located below the interface line in a vertical direction.

In addition, a scanning start position of the laser beam may be an inner end of the spiral scanning pattern, and a scanning end position of the laser beam may be an outer end of the spiral scanning pattern.

In addition, the laser beam may be radiated along the scanning pattern to form two joined portions along the interface line and provide a non-joined region between the two joined portions.

In addition, when a dimension of an outer edge of the scanning pattern in a first direction along the interface line is defined as W1, and a dimension of the outer edge in a second direction orthogonal to both the first direction and an optical axis direction of the laser beam is defined as W2, 0.3≤W2/W1≤1.0 may be satisfied.

In addition, the scanning pattern may have an elliptical spiral shape, and a dimension W1 of an outer edge of the scanning pattern in a first direction along the interface line may be larger than a dimension W2 of the outer edge in a second direction orthogonal to both the first direction and an optical axis direction of the laser beam.

According to one or more embodiments of the present invention, it is possible to provide the welding method capable of suppressing the occurrence of warpage in the thin plate-shaped metal member when the thin plate-shaped metal member is welded to another metal member.

### BRIEF DESCRIPTION OF THE DRAWINGS

FIG. 1 is a schematic view of a welding apparatus according to one or more embodiments.

FIG. 2 is a perspective view of a first metal member and a second metal member of FIG. 1.

FIG. 3 is a view of the vicinity of an interface line in FIG. 2 viewed from the optical axis direction of a laser beam.

FIG. 4 is a view showing a state after a laser beam is radiated along a scanning pattern shown in FIG. 3.

FIG. 5 is a sectional view taken along line V-V of FIG. 4.

FIG. 6 is a graph showing a relationship between the shape and joining area of the scanning pattern.

### DETAILED DESCRIPTION

Hereinafter, an example of a welding method according to one or more embodiments and a welding apparatus for performing the welding method will be described with reference to the drawings.

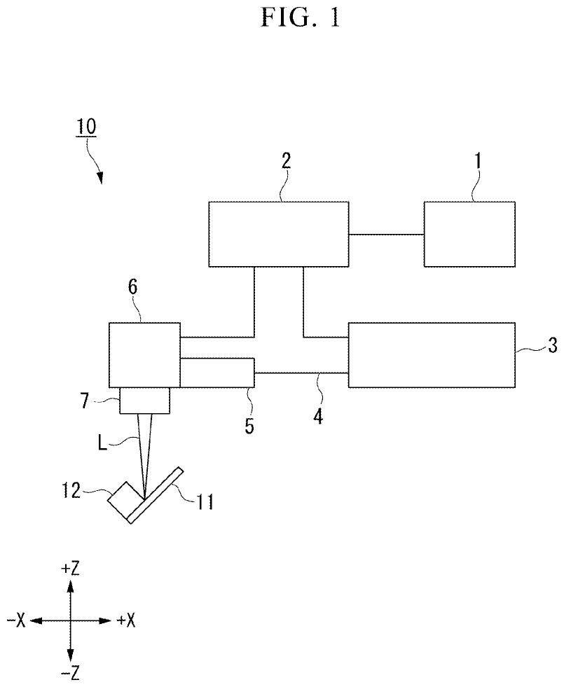

As shown in FIG. 1, the welding apparatus 10 includes an interface 1, a control unit 2, a laser oscillator 3, an optical fiber 4, a collimator unit 5, a scanner unit 6, and an fθ lens 7.

The welding apparatus 10 is configured to weld a first metal member 11 and a second metal member 12 by irradiating an interface portion between the first metal member 11 and the second metal member 12 with a laser beam L. In the present specification, the first metal member 11 and the second metal member 12, which are the objects to be welded, may be collectively referred to as simply “workpiece”.

Although the materials of the first metal member 11 and the second metal member 12 are not particularly limited, SUS (stainless steel) can be used, for example. The materials of the first metal member 11 and the second metal member may be the same or different.

In one or more embodiments, the first metal member 11 is plate-shaped and the second metal member 12 is block-shaped. The thickness of the first metal member 11 is not particularly limited, but is 1 mm or less, for example. In addition, both the first metal member 11 and the second metal member 12 may be plate-shaped.

The interface 1 is a personal computer (PC) or the like, and is configured to be capable of communicating with the control unit 2. The interface 1 and the control unit 2 are connected by wire or wireless. The interface 1 sets processing conditions such as a scanning pattern P to be described below and executes a processing program. The control unit 2 controls synchronization between the laser oscillator 3 and the scanner unit 6. The control unit 2 is connected to the laser oscillator 3 and the scanner unit 6 by wire. In addition, the control unit 2 controls the radiation position of the laser beam L on the workpiece.

The laser oscillator 3 generates a laser beam. As the laser oscillator 3, for example, a fiber laser can be used, but a laser device of another system may be used. The optical fiber 4 optically connects the laser oscillator 3 and the collimator unit 5 to each other. The laser beam generated by the laser oscillator 3 is transmitted to the collimator unit 5 by the optical fiber 4. The collimator unit 5 performs optical adjustment such that the laser beam emitted from the optical fiber 4 becomes parallel light.

The scanner unit 6 changes the traveling direction of the laser beam that has become parallel light by the collimator unit 5. The scanner unit 6 changes the radiation position of the laser beam L to the workpiece with the passage of time. That is, the laser beam L scans the surface of the workpiece by the scanner unit 6. The fθ lens 7 focuses the laser beam on the surface of the workpiece.

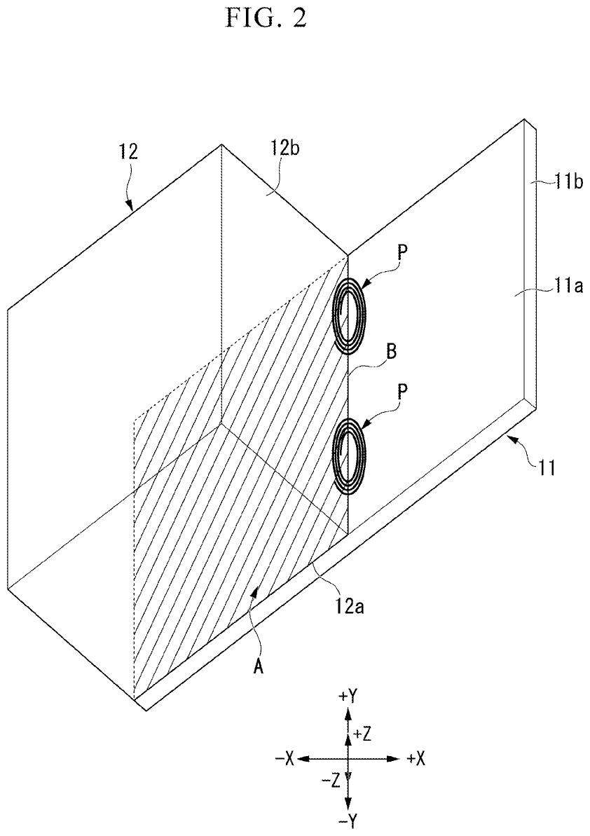

The first metal member 11 and the second metal member 12 are supported in a state of being in contact with each other by a supporting part (not shown) (for example, a clamp). FIG. 2 illustrates a state in which the first metal member 11 and the second metal member 12 are brought into contact with each other before both are welded. In the present specification, a region where the first metal member 11 and the second metal member 12 are in contact with each other is referred to as a contact region A. In addition, an interface line between the first metal member 11 and the second metal member 12 in a state where both are brought into contact with each other is referred to as an interface line B. The interface line B is a portion of the contour of the contact region A.

(Definition of Direction) In one or more embodiments, a positional relationship between the respective components will be described using an XYZ orthogonal coordinate system. A Z axis indicates a vertical direction (i.e., direction of gravity). In the vertical direction Z, a +Z side is an upper side and a −Z side is a lower side. In addition, a direction in which the interface line B extends is referred to as a first direction Y, and a direction orthogonal to both the first direction Y and the vertical direction Z is referred to as a second direction X. One side in the first direction Y is referred to as a +Y side, and the other side is referred to as a −Y side. One side in the second direction X is referred to as a +X side, and the other side is referred to as a −X side.

In the example of FIG. 1, the workpiece is located below the fθ lens 7, and the optical axis of the laser beam L is along the vertical direction Z. That is, an optical axis direction of the laser beam L is substantially parallel to the vertical direction Z, and the laser beam L emitted from fθ7 travels downward. However, the optical axis direction of the laser beam L may be inclined with respect to the vertical direction Z.

A curve P in FIG. 2 is an example of a scanning pattern of the laser beam L, and will be designated as a scanning pattern P below. The scanning pattern P in one or more embodiments has a spiral shape and straddles the interface line B. As shown in FIG. 2, a plurality of the scanning patterns P may be set on one interface line B. In this case, the plurality of scanning patterns P are arranged side by side in the first direction Y.

The first metal member 11 has a first contact surface 11a facing upward. The second metal member 12 has a second contact surface 12a facing downward and a side surface 12b facing the +X side. The side surface 12b extends in a direction intersecting the second contact surface 12a, and a corner portion is formed by the side surface 12b and the second contact surface 12a. The interface line B is located on the corner portion between the side surface 12b and the second contact surface 12a. The scanning pattern P is set on the first contact surface 11a of the first metal member 11 and on the side surface 12b of the second metal member 12.

The contact region A is a region where the first contact surface 11a of the first metal member 11 and the second contact surface 12a of the second metal member 12 are in contact with each other. The first contact surface 11a and the second contact surface 12a are flat surfaces, but actually have fine irregularities that a metal surface has. Due to the fine irregularities, a fine gap is formed between the first contact surface 11a and the second contact surface 12a.

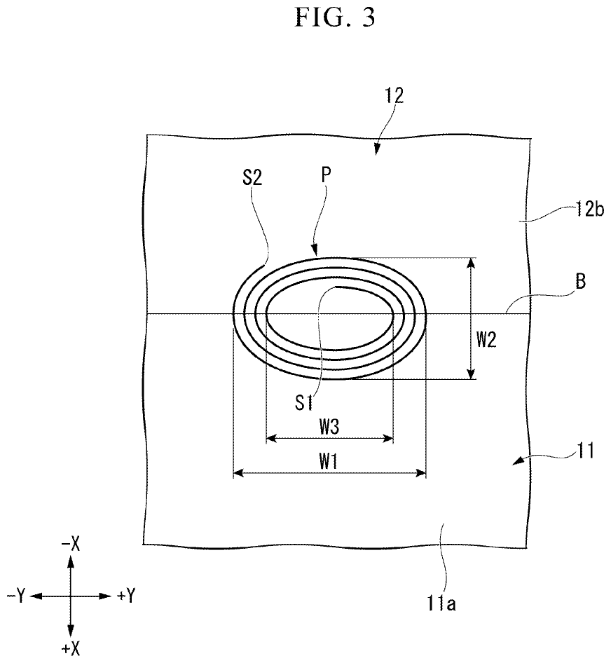

FIG. 3 is an enlarged view of the vicinity of the interface line B viewed from the optical axis direction of the laser beam L. In one or more embodiments, since the optical axis direction coincides with the vertical direction Z, FIG. 3 is a view (plan view) of the workpiece viewed from the upper side along the vertical direction. As shown in FIG. 3, when viewed from the optical axis direction of the laser beam L, the dimension of an outer edge of the scanning pattern P in the first direction Y is defined as W1 and the dimension of the outer edge of the scanning pattern P in the second direction X is defined as W2. In one or more embodiments, W1>W2 is satisfied. That is, when viewed in the optical axis direction of the laser beam L, the scanning pattern P has an elliptical spiral shape that is longer in the first direction Y than in the second direction X.

In addition, as shown in FIG. 3, the dimension of an inner edge of the scanning pattern P in the first direction Y is defined as W3 when viewed from the optical axis direction of the laser beam L. In the example of FIG. 3, the size of the dimension W3 is about 50% of the dimension W1, and the scanning pattern P has a spiral shape with a central portion thereof missing (omitting). That is, the scanning pattern P is not formed in the central portion.

A point S1 shown in FIG. 3 is an inner end of the scanning pattern P, and a point S2 is an outer end of the scanning pattern P. In one or more embodiments, the point S1 is a radiation start point when the laser beam L is radiated along the scanning pattern P, and the point S2 is a radiation end point. That is, in one or more embodiments, the laser beam L is scanned from the inside toward the outside of the spiral scanning pattern P. As shown in FIG. 3, in one or more embodiments, the points S1 and S2 are set on the second metal member 12. Accordingly, it is possible to suppress a warpage occurring in the thin plate-shaped first metal member 11. However, one or both of the points S1 and S2 may be set on the first metal member 11.

Next, the operation of the welding method in one or more embodiments will be described.

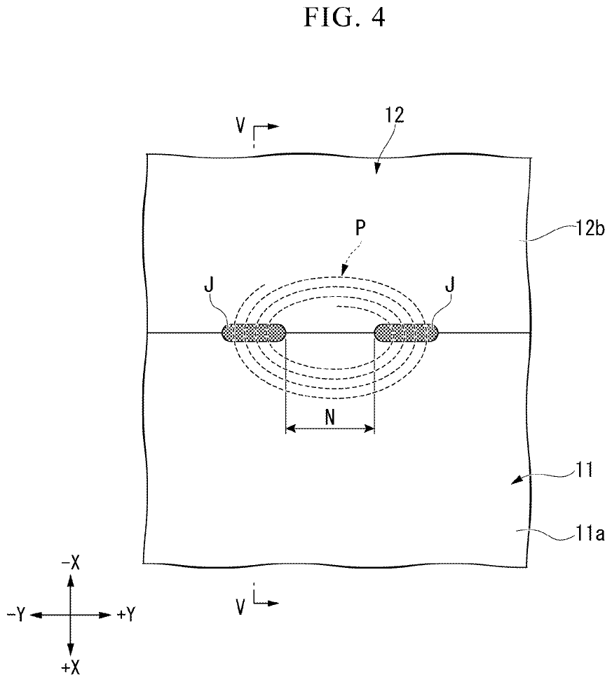

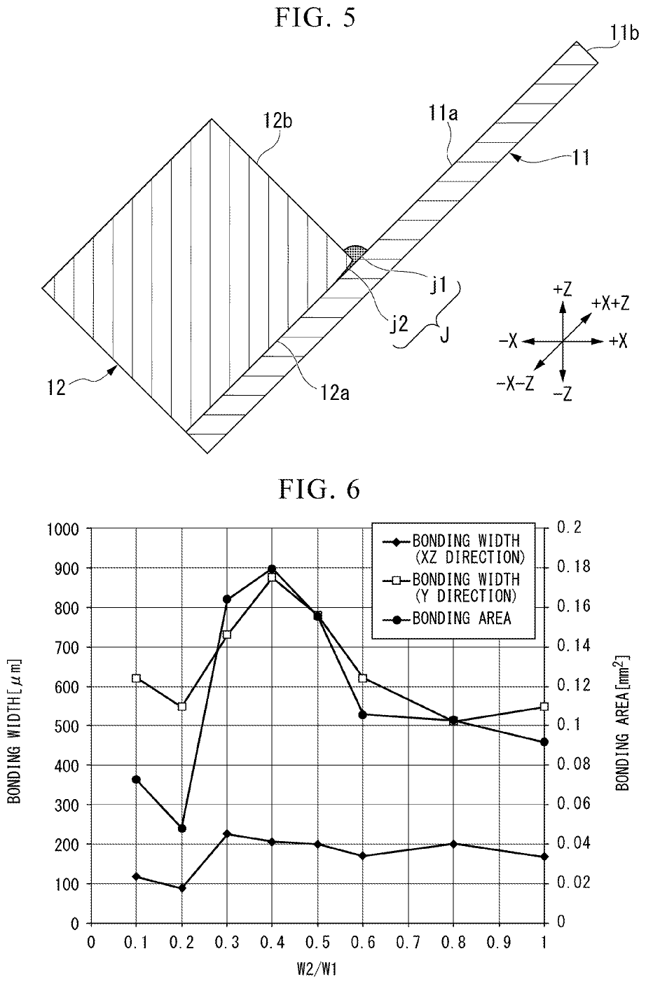

As shown in FIG. 1, the laser beam L generated by the laser oscillator 3 is radiated onto the workpiece via the optical fiber 4, the collimator unit 5, the scanner unit 6, and the fθ lens 7. The fθ lens 7 focuses the laser beam L such that a focal point is located on the interface line B between the first metal member 11 and the second metal member 12. In this case, the scanner unit 6 is controlled by the control unit 2 to scan the surface of the workpiece with the laser beam L along a predetermined scanning pattern P. The first metal member 11 and the second metal member 12 are heated by the laser beam L. The first metal member 11 and the second metal member are melted by heating and solidified in a state of being mixed with each other to form a joined portion J as shown in FIGS. 4 and 5. Accordingly, the first metal member 11 and the second metal member 12 are welded to each other.

The strength of the joining between the first metal member 11 and the second metal member 12 varies depending on the size of the joined portion J. Generally, the larger the area of the joined portion J (joining area), the greater the bonding strength. Thus, in one or more embodiments, the scanning pattern P is formed in a spiral shape to increase the radiation range. As a result, the joining area is increased. Moreover, since the spiral scanning pattern P is set to straddle the interface line B, the scanning pattern P crosses the interface line B multiple times. Accordingly, the joined portion J is capable of being more reliably formed on the interface line B. In particular, even in a case where the radiation position of the laser beam L has deviated due to an error in the apparatus, it is possible to suppress radiation of the laser beam L to a position deviated from the interface line B due to the deviation.

Moreover, since the scanning pattern P has a spiral shape, the first metal member 11 and the second metal member 12 that are melted with the scanning of the laser beam L are agitated. Accordingly, an interface between the first metal member 11 and the second metal member 12 is less likely to be formed inside the joined portion J, and the bonding strength is capable of being improved.

Here, for example, in a case where the scanning pattern P has a spiral shape extending to the central portion, it is considered that the central portion of the spiral is locally heated to high temperature by the energy of the laser beam L, and the first metal member 11 is deformed or warped. Thus, as shown in FIG. 3, the scanning pattern P according to one or more embodiments has a spiral shape with the central portion omitted (missed). Accordingly, the scanning pattern P is capable of being set such that the joined portion J is not formed in the portion of the interface line B corresponding to the central portion of the spiral. In this case, as shown in FIG. 4, two joined portions J are formed at a distance in the first direction Y. By adopting such a scanning pattern P, even if the first metal member 11 has, for example, a thin plate shape having a thickness of 1 mm or less, it is possible to suppress the warpage occurring in the first metal member 11 by the central portion of the spiral being locally heated.

In addition, as mentioned earlier, a minute gap is formed between the first contact surface 11a of the first metal member 11 and the second contact surface 12a of the second metal member 12. Therefore, the first metal member 11 and the second metal member 12, which have been melted into a liquid by the radiation of the laser beam, enter the inside of the gap due to the capillary force. Accordingly, as shown in FIG. 5, the joined portion J has a fillet portion j1 located on the interface line B, and an entry portion j2 that has entered the gap between the first metal member 11 and the second metal member 12. In this way, since the joined portion J has the fillet portion j1 and the entry portion j2, the joining area between the first metal member 11 and the second metal member 12 is increased, and the bonding strength is capable of being increased.

As described above, in the welding method according to one or more embodiments, the first metal member 11 and the second metal member 12 are brought into contact with each other, and the thin plate-shaped first metal member 11 and the second metal member 12 are welded to each other by radiating the laser beam L along the spiral scanning pattern P straddling the interface line B between the first metal member 11 and the second metal member 12. With this configuration, it is possible to secure the bonding strength while suppressing the occurrence of the warpage occurred by the first metal member 11 generating heat locally.

In addition, the contact region A between the first metal member 11 and the second metal member 12 is located below the interface line B in the vertical direction Z. For this reason, the first metal member 11 and the second metal member 12, which are melted into a liquid by being irradiated with the laser beam L, easily enter the gap between the first metal member 11 and the second metal member 12 due to their own weight. In this way, by utilizing not only the capillary force but also the gravity, it is possible to increase the amount of entry of the entry portion j2 and further increase the joining area.

In addition, in the example of FIG. 3, the point S1 that is the inner end of the scanning pattern P is a scanning start position of the laser beam L, and the point S2 that is the outer end of the scanning pattern P is a scanning end position of the laser beam L. In this way, by first irradiating the portion inside the spiral with the laser beam L to soften (or liquefy) the portion, the absorption efficiency of energy to the workpiece in the subsequent scanning of the laser beam L is high. Therefore, by radiating the laser beam L from the point S1 toward the point S2, in other words, from the inside toward the outside of the spiral, the workpiece is capable of being more efficiently heated by the laser beam L.

In addition, the scanning pattern P has a hollow spiral shape. Accordingly, excessive heating of the central portion of the spiral is capable of being suppressed. Moreover, as shown in FIG. 4, in a case where two joined portions J are formed at a distance in the first direction Y and a non-joined region N is provided between the two joined portions J, it is possible to more reliably suppress warping of the first metal member 11 that is a thin plate due to local heat generation. In addition, the non-joined region N may not be provided.

In addition, since the scanning pattern P has an elliptical spiral shape and the dimension W1 in the first direction Y is larger than the dimension W2 in the second direction X, the heat of the laser beam L is capable of being further centralized in the vicinity of the interface line B. Accordingly, it is possible to suppress the occurrence of warpage of the first metal member 11 due to unnecessary heating of the first metal member 11 at a position away from the interface line B.

### Example

The embodiments will be described below with reference to a specific example. In addition, the present invention is not limited to the following examples.

In the present example, a continuous wave (CW) single mode fiber laser having a rated output of 300 W and a wavelength of 1070 nm was used as the laser oscillator 3. The focal length of the collimator unit 5 was set to 75 mm A galvano scanner was used as the scanner unit 6. The focal length of the fθ lens 7 was 163 mm. As the first metal member 11, a thin SUS plate having a thickness of 0.3 mm was used. As the second metal member 12, a rectangular parallelepiped SUS block (20 mm×10 mm×5 mm) was used.

The first metal member 11 and the second metal member 12 (workpiece) was pressed and held by a clamp in a state where both were brought into contact with each other. In this case, the workpiece was held such that the first contact surface 11a of the first metal member 11 was inclined at 45° with respect to the vertical direction Z. The workpiece was positioned below the fθ lens 7 such that the focal point of the fθ lens 7 was aligned with the interface line B between the first metal member 11 and the second metal member 12. The optical axis direction of the laser beam L emitted from the fθ lens 7 was aligned with the vertical direction.

The scanning pattern P had an elliptical spiral shape with the central portion missed (omitted). The dimension W1 (refer to FIG. 3) was 0.75 mm, the dimension W2 was 0.3 mm, and the dimension W3 was 0.35 mm W2/W1=0.4. When the output of the laser oscillator 3 was 100 W and the scanning speed of the laser beam on the workpiece was 500 mm/s, two joined portions J as shown in FIG. 4 were formed. In addition, each joined portion J had a fillet portion j1 and an entry portion j2 as shown in FIG. 5, and the amount of entry of the entry portion j2 was 130 μm. Under this condition, it was confirmed that the first metal member 11 and the second metal member 12 were welded to each other with sufficient strength.

Next, the result obtained by examining the range of the value of W2/W1 will be described. Among the conditions of the above example, the value of W2/W1 was changed by changing the dimension W2 of the scanning pattern P. Other conditions are the same as above.

The horizontal axis of FIG. 6 indicates the value of W2/W1. The graph of the joining width (Y direction) indicates the width (μm) of the joined portion J in the first direction Y. The graph of the joining width (XZ direction) indicates the width (μm) of the joined portion J in the XZ direction. In addition, the XZ direction is a direction along a line that bisects an angle formed by the X axis and the Z axis when viewed from the Y direction, as shown in FIG. 5. The XZ direction is also a direction in which the first contact surface 11a and the second contact surface 12a extend when viewed from the Y direction. The graph of the joining area indicates the product of the value of the joining width (Y direction) and the value of the joining width (XZ direction). In addition, since the joined portion J is not strictly rectangular, the value of the joining area in FIG. 6 does not directly represent the area of the joined portion J. However, since the value of the joining area in FIG. 6 has a correlation with the actual area of the joined portion J, it is capable of being used as an index for comparing examining of the range of W2/W1.

It is considered that as the value of the joining area shown in FIG. 6 is larger, the strength of the joining between the first metal member 11 and the second metal member 12 at the joined portion J is larger. According to FIG. 6, by setting the scanning pattern P such that 0.3≤W2/W1≤1.0 is satisfied, the joining area is capable of being increased and the bonding strength is capable of being secured. In addition to this, when W2/W1<1.0 is satisfied, that is, when the scanning pattern P has an elliptical shape, the radiation area in which the laser light L is radiated at a portion away from the boundary line B is reduced. It is possible to suppress a warpage occurring in the workpiece since the influence of heat is suppressed. Based on the results in FIG. 6, in a case where the scanning pattern P has the elliptical shape, for example, 0.3≤W2/W1≤0.8 may be set. In addition, according to FIG. 6, by setting 0.3≤W2/W1≤0.5, the joining area becomes larger and the bonding strength is capable of being further improved.

In addition, the technical scope of the present invention is not limited to the above-described embodiments, and various modifications is capable of being made without departing from the spirit of the present invention.

For example, in the above embodiments, the scanning pattern P has a hollow spiral shape, but the scanning pattern P may extend up to the central portion of the spiral.

In addition, although the scanning pattern P has an elliptical spiral shape in the examples of FIGS. 2 to 4, the scanning pattern P may have a circular spiral shape. In addition, in a case where the scanning pattern P has a circular spiral shape, W2/W1=1.0 is satisfied.

In addition, the angle formed between the side surface 12b and the second contact surface 12a of the second metal member 12 may not be 90°.

In addition, in the embodiments, the first contact surface 11a of the first metal member 11 extends from the interface line B to the +XZ side, and an end surface 11b (refer to FIG. 2) of the first metal member 11 and a side surface 12b of the second metal member 12 was separated from each other. However, for example, the end surface 11b of the first metal member 11 and the side surface 12b of the second metal member 12 may be located on the same plane. In this case, the scanning pattern P may be set on the end surface 11b and the side surface 12b.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A welding method for welding a first metal member to a second metal member, where the first metal member is plate-shaped, the welding method comprising:
bringing the first metal member into contact with the second metal member; and
radiating a laser beam along a spiral scanning pattern straddling an interface line between the first metal member and the second metal member.

2. The welding method according to claim 1, wherein
the first metal member has a first contact surface that contacts the second metal member,
the second metal member has:
a second contact surface that contacts the first contact surface; and
a side surface that extends in a direction intersecting the second contact surface, and
the spiral scanning pattern is on the side surface and the first contact surface.

3. The welding method according to claim 1, wherein a contact region between the first metal member and the second metal member is below the interface line in a direction of gravity.

4. The welding method according to claim 1, wherein
a scanning start position of the laser beam is an inner end of the spiral scanning pattern, and
a scanning end position of the laser beam is an outer end of the spiral scanning pattern.

5. The welding method according to claim 1, wherein the laser beam
is radiated along the spiral scanning pattern,
forms two joined portions along the interface line, and
provides a non-joined region between the two joined portions.

6. The welding method according to claim 1, wherein 0.3≤W2/W1≤1.0 where W1 is a dimension of an outer edge of the spiral scanning pattern in a first direction along the interface line and W2 is a dimension of the outer edge in a second direction orthogonal to both the first direction and an optical axis direction of the laser beam.

7. The welding method according to claim 1, wherein
the spiral scanning pattern has an elliptical spiral shape, and
a dimension W1 of an outer edge of the spiral scanning pattern in a first direction along the interface line is larger than a dimension W2 of the outer edge in a second direction orthogonal to both the first direction and an optical axis direction of the laser beam.
